(19) United States
(12) Patent Application Publication
(10) Pub. No.: US 2026/0017051 A1
(43) Pub. Date: Jan. 15, 2026

(54) SPECIAL INPUT FORMATTING FOR BINARY INPUT DATA TO BE ABLE TO PROCESS AS SAME THROUGHPUT AS SMALLER BINARY DATA

(71) Applicant: Tesla, Inc., Austin, TX (US)

(72) Inventors: Ritvik RAWAT, Sunnyvale, CA (US); Hasan UNLU, Mountain View, CA (US); Srihari SADHU SAMPATHKUMAR, Palo Alto, CA (US)

(73) Assignee: Tesla, Inc., Austin, TX (US)

(21) Appl. No.: 19/259,922

(22) Filed: Jul. 3, 2025

Related U.S. Application Data
(60) Provisional application No. 63/669,074, filed on Jul. 9, 2024.

(51) Int. Cl. G06F 9/30; G06F 7/50; G06F 7/523; G06F 9/38

(52) U.S. Cl. CPC G06F 9/3001; G06F 7/50; G06F 7/523; G06F 9/3887

(57) ABSTRACT

Embodiments include systems and methods for special input formatting for binary input data to be able to process the binary input data as smaller binary data. A method can be performed by a circuit comprising a multiplier-accumulator (MAC) for convolving a data structure with weights of a machine learning model. The method includes obtaining first and second values having a first bit-width. The method includes generating, using a multiplication function of the MAC, a first product using the first value and a first predefined weight, the multiplication function, thereby left shifting the first product. The method includes generating, using the multiplication function, an output word using the first product, the second value, and a second predefined weight. The method includes storing, upon receipt of an instruction, a respective first and second portion of the output word to a first and second addressable location.

### CROSS-REFERENCE TO RELATED APPLICATION

This application claims priority to U.S. Provisional Application No. 63/669,074, filed Jul. 9, 2024, which is incorporated by reference in its entirety and for all purposes.

### TECHNICAL FIELD

This disclosure relates generally to augmenting an effective number of bits for a hardware pipeline. For example, the bit augmentation can be realized for multiplier-accumulators in a machine learning implementation.

### BACKGROUND

Convolutional neural networks (CNNs) were one of the earliest and most significant type of machine learning network, especially in the domain of computer vision. In recent years, machine learning has undergone a meteoric rise, revolutionizing industries and reshaping our technological landscape. Breakthroughs in architecture methodologies, including deep learning, have led to unprecedented levels of performance in tasks such as image recognition/computer vision, natural language processing, and autonomous driving. However, the increased precision of such approaches can prove expensive in terms of power budgets, die area, and other design considerations.

Moreover, a product lifecycle for some goods including graphics processing units (GPU), automobiles, robotics, and so forth, can span decades-several generations of algorithmic development. Even where such products include substantial computational headroom to support updated algorithms, the types of hardware accelerators used may evolve over time, leading to mismatches between a type of hardware in a deployed product and the components that may be associated with an updated model. Improvements in the art are desired.

### SUMMARY

A hardware component can include arrayed multipliers to execute convolutional processes (e.g., of a convolutional neural network). For example, the arrayed multipliers can include multiplier-accumulators (MACs). However, some operations can be performed using bit-widths wider than the fixed bit-width of the MACs. The data used in these operations is sometimes referred to as bit-augmented data. For example, a data bus operatively coupled with the MAC can provide data at lower degrees of precision achievable by other circuit components. Such an approach can be applied to achieve increased precision from existing lower precision hardware components, or can be used in new designs.

Inclusion of lower bit-width data or components, such as interconnects, busses, processor cores, memory device, registers, or other forms logic units and devices, in new designs can reduce power consumption according to a reduced number of signal state transitions or reduced size and power of bus drivers. The lower bit-width can also reduce circuit area used for routing (or increase line-to-line spacing to improve signal integrity) and may reduce an interconnect density in multi-chip modules, or between functional blocks of a monolithic device. This reduction in power usage or circuit area can exceed the power usage or circuit area used by a MAC. Moreover, even where the inclusion of the MAC leads to a net increase in area or power, the MAC can be placed away from density-critical areas or thermal hot spots, leading to overall improvement to device thermals, die area or so forth. Further still, application of the techniques of the present disclosure can aid in the re-use of an existing computing device for higher precision data than originally intended. For example, many implementations of convolutional neural networks (CNNs) have been supplemented with higher resolution CNNs, transformer models, attention mechanisms, or other implementations that can use varying hardware resources or bit precision (e.g., lesser or greater precision, such as by replacing an 8-bit dataflow with a 16-bit data flow). Accordingly, compute devices tasked with implementing newer techniques may not only suffer from a lack of some hardware components, the compute devices can also include components that are underutilized according to updated models.

Some hardware components, when executing operations related to one or more layers of a machine learning model, can use less than a number of available MACs or other multipliers. However, such hardware components may be bandwidth-constrained for some operations. According to the present disclosure, the hardware components can use the MACs or other multipliers to pack multiple data elements having a bit-width of n into a register or other location having a bit-width of less than 2n. Another component can unpack the separate data elements, such that a total realized bandwidth may exceed a number of data elements per instruction of a hardware component (e.g., the packed bits can be conveyed over a pipeline bottleneck and thereafter unpacked, increasing a realized bandwidth).

In some embodiments, a method for data transport including: obtaining, by a circuit including a multiplier-accumulator (MAC) for convolving a data structure with weights of a machine learning model, a first value of the data structure having a first bit-width and a second value of the data structure not exceeding the first bit-width; generating, using a multiplication function of the MAC of the circuit, a first product using the first value and a first predefined weight, the multiplication function, thereby left shifting the first product; generating, using the multiplication function of the MAC of the circuit, an output word using the first product, the second value, and a second predefined weight; and storing, upon receipt of an instruction, a first portion of the output word to a first addressable location and a second portion of the output word to a second addressable location, different from the first addressable location, whereby a cumulative size of the first addressable location and the second addressable location exceeds the first bit-width.

The method may further include simultaneously storing, in an accumulation register of the MAC, the first product and a second product of the second value and the second predefined weight. The first product may be stored at a first portion of the accumulation register and the second product stored at a second portion of the accumulation register. The method may further include providing the output word to a single instruction multiple data (SIMD) component configured to store the first portion of the output word to the first addressable location and the second portion of the output word to the second addressable location responsive to a same instance of the instruction. The first addressable location and the second addressable location may be addressable by a component in a pipeline including the SIMD component and the MAC. The component may be disposed downstream of the SIMD component and the MAC.

The first value and the second value may have a format including at least one of a bfloat15 (BF15) data format or a bfloat16 (BF16) data format. The left shift may include a shift by fewer bits than the first bit-width. A data format for the output word may include a sign bit for an uppermost bit. Each of the first value, the second value, the first predefined weight, and the second predefined weight may be natural numbers. The second predefined weight can be one.

The instruction may be received as one of a rising edge or a falling edge. The first value and the second value may be obtained, by the MAC, via a serial stream. The first value and the second value may include pixel data for a first and second pixel of an image.

In some embodiments, a system for data transport that includes a circuit including a multiplier-accumulator (MAC) for convolving a data structure with weights of a machine learning model. The circuit may be obtain a first value of the data structure having a first bit-width and a second value of the data structure not exceeding the first bit-width; generate, using a multiplication function of the MAC, a first product using the first value and a first predefined weight, the multiplication function, thereby left shifting the first product; generate, using the multiplication function of the MAC, an output word using the first product, the second value, and a second predefined weight; and store, upon receipt of an instruction, a first portion of the output word to a first addressable location and a second portion of the output word to a second addressable location, different from the first addressable location, whereby a joint cumulative size of the first addressable location and the second addressable location exceeds the first bit-width.

The circuit may be configured to store, simultaneously, in an accumulation register of the MAC, the first product and a second product of the second value and the second predefined weight. The first product may be stored at a first portion of the accumulation register and the second product may be stored at a second portion of the accumulation register. The circuit may be configured to provide the output word to a single instruction multiple data (SIMD) component. The circuit or the SIMD component may be configured to store the first portion of the output word to the first addressable location and the second portion of the output word to the second addressable location responsive to a same instance of the instruction. The first addressable location and the second addressable location may be addressable by a component in a pipeline including the SIMD component and the MAC. The component may be disposed downstream of the SIMD component and the MAC.

The first value and the second value may have a format including at least one of: a bfloat15 (BF15) data format or a bfloat16 (BF16) data format. The left shift may be a shift by fewer bits than the first bit-width. A data format for the output word may include a sign bit for an uppermost bit. Each of the first value, the second value, the first predefined weight, and the second predefined weight may be natural numbers. The MAC may be configured to obtain the first value and the second value via a register transfer of the first bit-width. The second predefined weight can be one.

In some embodiments, an autonomous vehicle includes one or more sensors and a circuit. The one or more sensors may be configured to generate a data structure having a plurality of data elements. The circuit may include a multiplier-accumulator (MAC) for convolving the data structure with weights of a machine learning model and configured to obtain a first value having a first bit-width and a second value having the first bit-width; generate, using a multiplication function of the MAC, a first product using the first value and a first predefined weight, the multiplication function, thereby left shifting the first product; generate, using the multiplication function of the MAC, an output word using the first product, the second value, and a second predefined weight; and store, upon receipt of an instruction, a first portion of the output word to a first addressable location and a second portion of the output word to a second addressable location, different from the first addressable location, whereby a joint cumulative size of the first addressable location and the second addressable location exceeds a per-instruction bandwidth of the circuit.

The circuit may be configured to provide the output word to a single instruction multiple data (SIMD) component. The circuit or the SIMD component may be configured to store the first portion of the output word to the first addressable location and the second portion of the output word to the second addressable location responsive to a same instance of the instruction. The first addressable location and the second addressable location may be addressable by a component in a pipeline including the SIMD component and the MAC. The component may be disposed downstream of the SIMD component and the MAC.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled visual data analysis system for egos, according to an embodiment.

FIG. 1B illustrates various sensors associated with vehicle (or other type of ego), according to an embodiment.

FIG. 1C illustrates the components of an ego, according to an embodiment.

FIG. 1D shows certain hardware and software components of the ego for performing full or partial self-driving (SD) operations, according to an embodiment.

FIG. 2 illustrates an example of a flow diagram for a transfer of bit-augmented binary-coded information, according to some embodiments.

FIG. 3 illustrates an example of a hardware pipeline, according to some embodiments.

FIG. 4 illustrates an example of a state of a multiplier-accumulator (MAC) incident to a receipt of instructions therefor, according to some embodiments.

FIG. 5 illustrates an example of a method of bit-augmented data transference, according to some embodiments.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Embodiments described herein include systems and methods related to bit augmented arithmetic convolution. A CNN can be executed according to many parallel multiplier-accumulators (MACs). However, when implemented in hardware, such as in the case of an application specific integrated circuit (ASIC), a MAC can include a predefined bit width, corresponding to a data path of a design architecture. Accordingly, it may be challenging to efficiently process higher resolution data than an ASIC was originally designed for. Further, as described above, various designs including reduced bit-width data busses can exhibit reduced power usage, and die area, among other benefits. According to the present disclosure, convolutional processes (e.g., as implemented by MAC blocks) can be used to generate data flows for higher resolution models than are natively supported by some hardware components. In some embodiments, the systems and methods disclosed herein can be implemented at a compiler or a low-level of a stack such that the particular hardware implementation may be realized transparently to a change to a model or other application-level software. For example, the systems realized according to the present disclosure can operate at a precision, data throughput, or performance as hardware having a native bit-width equal to a bit-width of a model, even when some hardware components have a lower bit-width than the bit-width of the model.

More particularly, hardware components such as a multiplier-accumulator (MAC) can be used to pack multiple inputs into a single bit augmented word (referred to as a packed word) at an accumulator. For example, the MAC can receive a first predefined weight to place a first or second byte into a MSB of a 16-bit word of an accumulator (e.g., according to an endian-ness of the input data). A data flow can pass the packed words to a memory device, logic unit, or other component. For example, some applications can use an eight-bit data path to provide sixteen-bit data between portions of a circuit. Such an architecture can provide a low-signal count data path for sparse data, or can increase a total bandwidth for data transfer. In some embodiments, the packed data can be provided to a single-instruction multiple-data (SIMD) component. For example, the SIMD component can take, as input, the packed data of the MAC accumulator and output the results into separate memory locations. In this way, the circuit may use a narrower pipeline to process data of higher bit-width. That is, although the SIMD can operate at a same rate as for a native (e.g., skinnier) data bus, a throughput of the SIMD can be effectively doubled. For example, where a MAC is configured to output a sixteen-bit value determined according to a convolution of an 8-bit input with an 8-bit of weighting, a SIMD at the output of the MAC can be configured to handle 16-bit values. By using the MAC to pack two bytes into every word (e.g., using the MAC as a shift register for every other byte), the SIMD can pass two data values per instruction/cycle, and provide two outputs for a later process at a data rate that is double the native data rate of the hardware component.

It should be appreciated that embodiments are not limited to any particular bit-width or data format discussed herein. The predefined weights used for left-shifting and combining values may be selected to accommodate a wide range of data formats, including but not limited to those listed above. Non-limiting examples of the types of data formats may include bfloat15 (BF15), bfloat16 (BF16), 12-bit image data, 7+8-bit paired values, 4-bit grayscale image data, 16-bit fixed-point values, and 10-bit sensor data, among others.

As an example, in the case of an input data format of bfloat15 (BF15), a first value may be a MSB and a second value may be LSB, where the MSB is left-shifted by 7 bits using a predefined weight (e.g., 128), and the LSB is added directly using a weight of 1. This results in a 15-bit packed value that can be stored in 8 bit registers/memory locations and processed using an 8-bit MAC pipeline.

As another example, in the case of bfloat16 (BF16), the first value may represent the most significant 8 bits of a 16-bit floating-point value, and the second value may represent the least significant 8 bits. The MSB is left-shifted by 8 bits using a predefined weight (e.g., 256), and the LSB is added directly using a weight of 1. This results in a 16-bit packed value that can be processed using a MAC pipeline configured for 8-bit inputs.

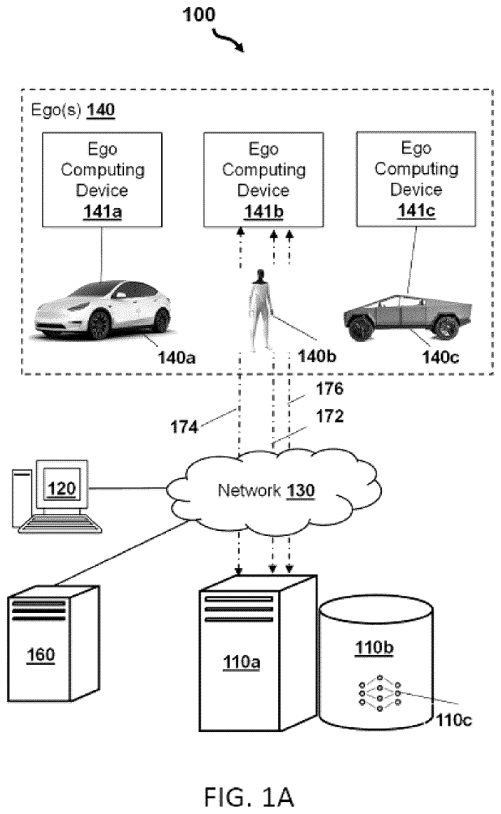

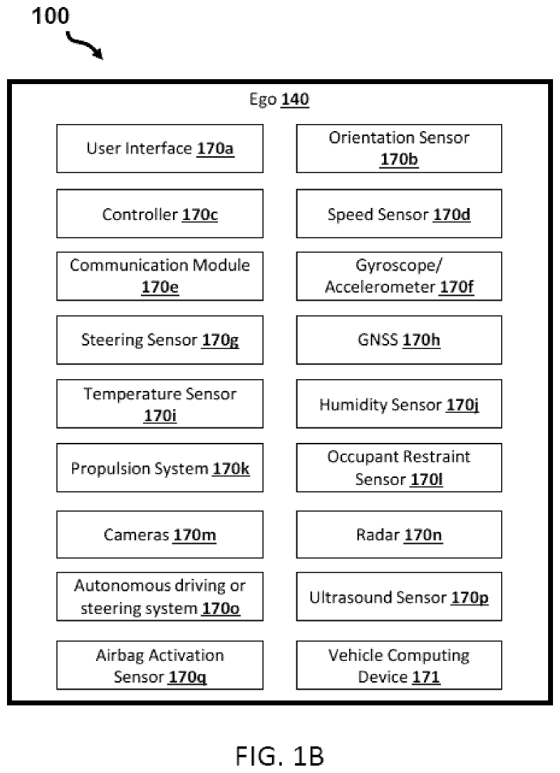

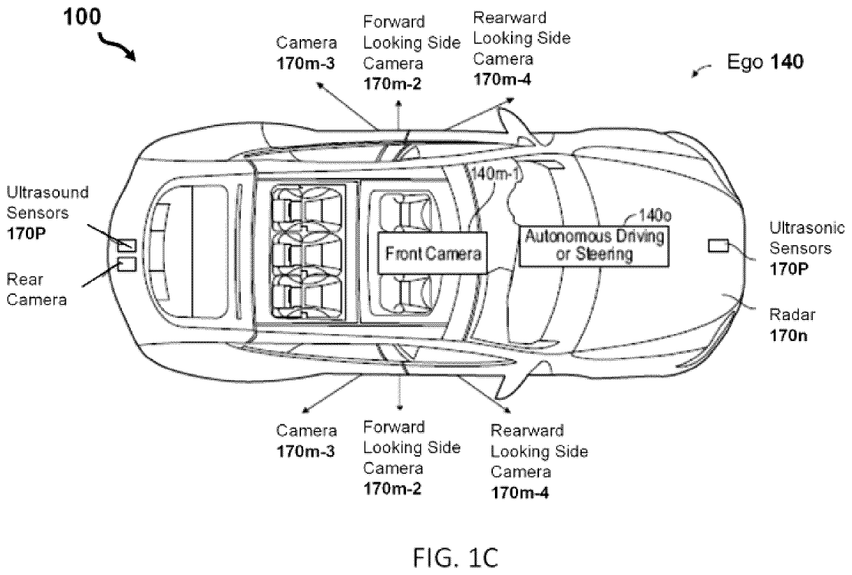

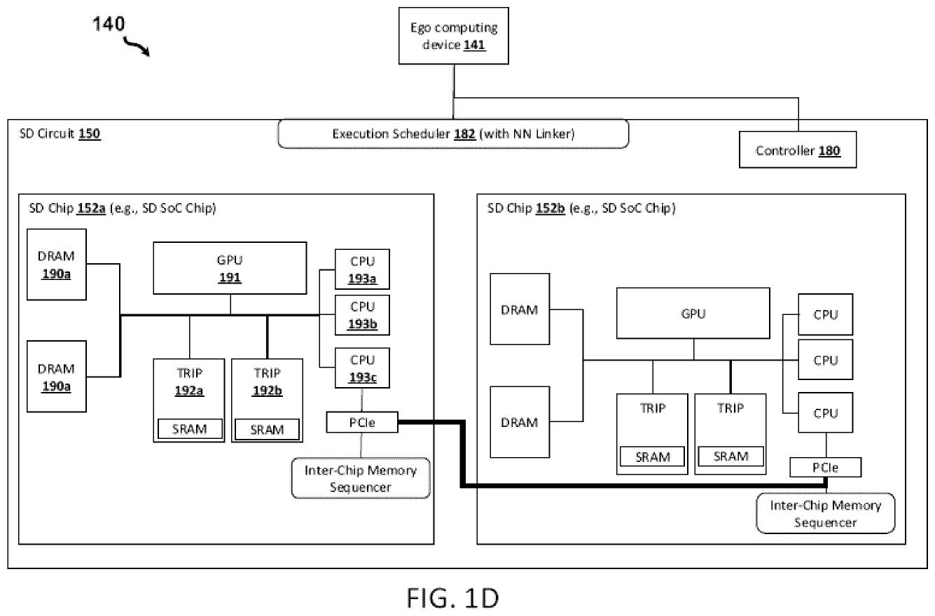

FIG. 1A is a non-limiting example of components of a system 100 in which the methods and systems discussed herein can be implemented. For instance, an analytics server may train an AI model and use the trained AI model to generate an occupancy dataset and/or map for one or more egos. FIG. 1A illustrates components of an AI-enabled visual data analysis system 100. The system 100 may include an analytics server 110a, a system database 110b, an administrator computing device 120, egos 140a-140b (collectively ego(s) 140), ego computing devices 141a-141c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 mi, 100 ft) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-1C illustrate block diagrams of sensors integrated within the egos 140, according to an embodiment. The number and position of each sensor discussed with respect to FIGS. 1B-1C may depend on the type of ego 140 discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior- or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 1700 configured to use data collected via various sensors (e.g., radar 170n, speed sensor 170d, and/or ultrasound sensors 170p) to autonomously navigate the ego 140.

Therefore, autonomous driving or steering system 1700 may analyze various data collected by one or more sensors described herein to identify driving data. For instance, autonomous driving or steering system 1700 may calculate a risk of forward collision based on the speed of the ego 140 and its distance to another vehicle on the road. The autonomous driving or steering system 1700 may also determine whether the driver is touching the steering wheel. The autonomous driving or steering system 1700 may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-1C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how the AI model(s) 110c can be trained, the analytics server 110a may collect data from egos 140 to train the AI model(s) 110c. Before executing the AI model(s) 110c to generate/predict an occupancy dataset, the analytics server 110a may train the AI model(s) 110c using various methods. The training allows the AI model(s) 110c to ingest data from one or more cameras of one or more egos 140 (without the need to receive radar data) and predict occupancy data for the ego's surroundings. The operation described in this example may be executed by any number of computing devices operating in the distributed computing system described in FIGS. 1A-1D (e.g., a processor of the egos 140).

The analytics server 110a may generate, using a sensor of an ego 140, a first dataset having a first set of data points where each data point within the first set of data points corresponds to a location and a sensor attribute of at least one voxel of space around the egos 140, the sensor attribute indicating whether the at least one voxel is occupied by an object having mass.

To train the AI model(s) 110c, the analytics server 110a may first employ one or more of the egos 140 to drive a particular route. While driving, the egos 140 may use one or more of their sensors (including one or more cameras) to generate navigation session data. For instance, the one or more of the egos 140 equipped with various sensors can navigate the designated route. As the one or more of the egos 140 traverse the terrain, their sensors may capture continuous (or periodic) data of their surroundings. The sensors may indicate an occupancy status of the one or more egos' 140 surroundings. For instance, the sensor data may indicate various objects having mass in the surroundings of the one or more of the egos 140 as they navigate their route.

The analytics server 110a may generate a first dataset using the sensor data received from the one or more of the egos 140. The first dataset may indicate the occupancy status of different voxels within the surroundings of the one or more of the egos 140. As used herein in some embodiments, a voxel is a three-dimensional pixel, forming a building block of the surroundings of the one or more of the egos 140. Within the first dataset, each voxel may encapsulate sensor data indicating whether a mass was identified for that particular voxel. Mass, as used herein, may indicate or represent any object identified using the sensor. For instance, in some embodiments, the egos 140 may be equipped with an emitter that identifies a mass by emitting pulses and measuring the time it takes for these pulses to travel to an object (having mass) and back. These sensor systems may operate based on the principle of measuring the distance between the emitter/sensor and objects in its field of view. This information, combined with other sensor data, may be analyzed to identify and characterize different masses or objects within the surroundings of the one or more of the egos 140.

Various additional data may be used to indicate whether a voxel of the one or more egos 140 surroundings is occupied by an object having mass or not. For instance, in some embodiments, a digital map of the surroundings (e.g., a digital map of the route being traversed by the ego) of the one or more egos 140 may be used to determine the occupancy status of each voxel.

In operation, as the one or more egos 140 navigate, their sensors collect data and transmit the data to the analytics server 110a, as depicted in the data stream 176. For instance, the ego 140 computing devices 141 may transmit sensor data to the analytics server 110a using the data stream 176.

The analytics server 110a may generate, using a camera of the ego 140, a second dataset having a second set of data points where each data point within the second set of data points corresponds to a location and an image attribute of at least one voxel of space around the ego 140.

The analytics server 110a may receive a camera feed of the one or more egos 140 navigating the same route as in the first step. In some embodiments, the analytics server 110a may simultaneously (or contemporaneously) perform the first step and the second step. Alternatively, two (or more) different egos 140 may navigate the same route where one ego transmits its sensor data, and the second ego 140 transmits its camera feed.

The one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos' 140 surroundings are included within the second dataset.

In operation, as the one or more egos 140 navigate, their cameras collect data and transmit the data to the analytics server 110a, as depicted in the data stream 172. For instance, the ego computing devices 141 may transmit image data to the analytics server 110a using the data stream 172.

The analytics server 110a may train an AI model using the first and second datasets, whereby the AI model 110c correlates each data point within the first set of data points with a corresponding data point within the second set of data points, using each data point's respective location to train itself, wherein, once trained, the AI model 110c is configured to receive a camera feed from a new ego 140 and predict an occupancy status of at least one voxel of the camera feed.

Using the first and second datasets, the analytics server 110a may train the AI model(s) 110c, such that the AI model(s) 110c may correlate different visual attributes of a voxel (within the camera feed within the second dataset) to an occupancy status of that voxel (within the first dataset). In this way, once trained, the AI model(s) 110c may receive a camera feed (e.g., from a new ego 140) without receiving sensor data and then determine each voxel's occupancy status for the new ego 140.

The analytics server 110a may generate a training dataset that includes the first and second datasets. The analytics server 110a may use the first dataset as ground truth. For instance, the first dataset may indicate the different location of voxels and their occupancy status. The second dataset may include a visual (e.g., a camera feed) illustration of the same voxel. Using the first dataset, the analytics server 110a may label the data, such that data record(s) associated with each voxel corresponding to an object are indicated as having a positive occupancy status.

The labeling of the occupancy status of different voxels may be performed automatically and/or manually. For instance, in some embodiments, the analytics server 110a may use human reviewers to label the data. For instance, as discussed herein, the camera feed from one or more cameras of a vehicle may be shown on an electronic platform to a human reviewer for labeling. Additionally or alternatively, the data in its entirety may be ingested by the AI model(s) 110c where the AI model(s) 110c identifies corresponding voxels, analyzes the first digital map, and correlates the image(s) of each voxel to its respective occupancy status.

Using the ground truth, the AI model(s) 110c may be trained, such that each voxel's visual elements are analyzed and correlated to whether that voxel was occupied by a mass. Therefore, the AI model 110c may retrieve the occupancy status of each voxel (using the first dataset) and use the information as ground truth. The AI model(s) 110c may also retrieve visual attributes of the same voxel using the second dataset.

In some embodiments, the analytics server 110a may use a supervised method of training. For instance, using the ground truth and the visual data received, the AI model(s) 110c may train itself, such that it can predict an occupancy status for a voxel using only an image of that voxel. As a result, when trained, the AI model(s) 110c may receive a camera feed, analyze the camera feed, and determine an occupancy status for each voxel within the camera feed (without the need to use a radar).

The analytics server 110a may feed the series of training datasets to the AI model(s) 110c and obtain a set of predicted outputs (e.g., predicted occupancy status). The analytics server 110a may then compare the predicted data with the ground truth data to determine a difference and train the AI model(s) 110c by adjusting the AI model's 110c internal weights and parameters proportional to the determined difference according to a loss function. The analytics server 110a may train the AI model(s) 110c in a similar manner until the trained AI model's 110c prediction is accurate to a certain threshold (e.g., recall or precision).

Additionally or alternatively, the analytics server 110a may use an unsupervised method where the training dataset is not labeled. Because labeling the data within the training dataset may be time-consuming and may require excessive computing power, the analytics server 110a may utilize unsupervised training techniques to train the AI model 110c.

After the AI model 110c is trained, it can be used by an ego 140 to predict occupancy data of the one or more egos' 140 surroundings. For instance, the AI model(s) 110c may divide the ego's surroundings into different voxels and predict an occupancy status for each voxel. In some embodiments, the AI model(s) 110c (or the analytics server 110a using the data predicted using the AI model 110c) may generate an occupancy map or occupancy network representing the surroundings of the one or more egos 140 at any given time.

In another example of how the AI model(s) 110c may be used, after training the AI model(s) 110c, analytics server 110a (or a local chip of an ego 140) may collect data from an ego (e.g., one or more of the egos 140) to predict an occupancy dataset for the one or more egos 140. This example describes how the AI model(s) 110c can be used to predict occupancy data in real-time or near real-time for one or more egos 140. This configuration may have a processor, such as the analytics server 110a, execute the AI model. However, one or more actions may be performed locally via, for example, a chip located within the one or more egos 140. In operation, the AI model(s) 110c may be executed via an ego 140 locally, such that the results can be used to autonomously navigate itself.

The processor may input, using a camera of an ego object 140, image data of a space around the ego object 140 into an AI model 110c. The processor may collect and/or analyze data received from various cameras of one or more egos 140 (e.g., exterior-facing cameras). In another example, the processor may collect and aggregate footage recorded by one or more cameras of the egos 140. The processor may then transmit the footage to the AI model(s) 110c trained using the methods discussed herein.

The processor may predict, by executing the AI model 110c, an occupancy attribute of a plurality of voxels. The AI model(s) 110c may use the methods discussed herein to predict an occupancy status for different voxels surrounding the one or more egos 140 using the image data received.

The processor may generate a dataset based on the plurality of voxels and their corresponding occupancy attribute. The analytics server 110a may generate a dataset that includes the occupancy status of different voxels in accordance with their respective coordinate values. The dataset may be a query-able dataset available to transmit the predicted occupancy status to different software modules.

In operation, the one or more egos 140 may collect image data from their cameras and transmit the image data to the processor (placed locally on the one or more egos 140) and/or the analytics server 110a, as depicted in the data stream 172. The processor may then execute the AI model(s) 110c to predict occupancy data for the one or more egos 140. If the prediction is performed by the analytics server 110a, then the occupancy data can be transmitted to the one or more egos 140 using the data stream 174. If the processor is placed locally within the one or more egos 140, then the occupancy data is transmitted to the ego computing devices 141 (not shown in FIG. 1A).

Using the methods discussed herein, the training of the AI model(s) 110c can be performed such that the execution of the AI model(s) 110c may be performed locally on any of the egos 140 (at inference time). The data collected (e.g., navigational data collected during the navigation of the egos 140, such as image data of a trip) can then be fed back into the AI model(s) 110c, such that the additional data can improve the AI model(s) 110c.

FIG. 1D shows certain hardware and software components of the ego 140 for performing full or partial self-driving (SD) operations, according to an embodiment. The ego 140 comprises an SD circuit 150 and the ego computing device 141, which may include the same or different components of the SD circuit 150. The SD circuit 150 includes SD chips 152a-152b (generally referred to as SD chip 152), such as system-on-chip (SoC) integrated circuit chips. Each SD chip 152 includes non-transitory machine-readable memories, such as Dynamic Random-Access Memories (DRAMs) 190a-190b (generally referred to as DRAMs 190) and SRAMs. The SD chip 152 further includes various types of processing units, including a GPU 191, central processing units (CPUs) 193a-193c (generally referred to as CPUs 193), and specially designed Tera-op, Reliable, Intelligently adaptive Processing System (TRIP) processing units 192a-192b (generally referred to as TRIP units 192).

As mentioned, the ego computing device 141 may execute various software programming operations for managing operations of the SD circuit 150 (or other hardware), which may include execution instructions for applying the neural network architecture on the types of sensor data from the sensors of the ego 140. The operations of the ego computing device 141 may further include, for example, compiling execution instructions for the SD circuit 150 to perform certain functions of the neural network architecture or for operating the ego 140.

In the example embodiment, the SD circuit 150 comprises two SD chips 152a-152b. In many cases, the SD chips 152 function in a redundancy mode or failover mode of operation, where a first SD chip 152a functions as a primary chip and a second SD chip 152b functions as a secondary chip. For example, the first SD chip 152a is prioritized to execute most of the executable instructions, and the second SD chip 152b is invoked to operate as failover or redundancy in the event of problems with the first SD chip 152a.

The ego 140, however, may comprise an SD circuit 150 that operates in an extended compute mode that balances the execution instruction pipelines amongst SD chips 152. As an example, the ego computing device 141 executes software routines for compiling the execution instructions to be performed by the processing units 191-193 of the SD chips 152, and distributing the execution instructions to the optimal hardware components of the SD circuit 150.

In some embodiments, the ego 140 comprises a controller 180 that performs various operations for managing the SD circuit 150. The controller 180 may perform various functions according to, for example, instructions from the ego computing device 141 (or other component of the ego 140) or configuration inputs from an administrative user. For instance, the controller 180 toggles, configures, or otherwise instructs the SD circuit 150 to operate in the various operational modes. In some circumstances, for example, the controller 180 instructs the SD circuit 150 to operate in an extended compute mode in which the first SD chip 152a executes a first instruction partition of the execution instructions and the second SD chip 152b executes a second instruction partition. As another example, in some circumstances, the controller 180 instructs the SD circuit 150 to operate in a failover mode in which the second SD chip 152b executes the execution instructions when the first SD chip 152a fails.

The SD chip 152 includes one or more DRAMs 190 or other types of non-transitory memories for storing data inputs for the SD chip 152. The data inputs may be stored in the DRAM 190 for the processing units to reference for various computations. In some configurations, the TRIP units 192 include SRAMs, such that the SD chip 152 moves the data from a DRAM 190 for storage into the SRAM of the TRIP unit 192. The TRIP unit 192 executes the computation according to the execution instructions and moves the data back to the DRAM 190 or other destination of the SD circuit 150.

The SD chip 152 includes various types of processing units, which may include any hardware integrated circuit (IC) processor device capable of performing the various processes and tasks described herein. Non-limiting examples of the types of processing units include GPUs 191, CPUs 193, TRIP units 192, microcontrollers, ALUs, ASICs, and FPGAs, among others. The processing units may perform the computational functions of the programming layers defining the neural network architectures or sub-architectures. The compilers output the execution instructions representing the operations of the neural network architecture, executed by the ego computing device 141 (or other component of the ego 140).

The TRIP units 192 are designed specifically for the neural network operations, beneficially focusing on improvements to, for example, optimizing power and performance (e.g., low latency). The TRIP units 192 include hardware IC devices (e.g., microcontrollers, ALUs, ASICS, FPGAs, processor devices) designed for fast operations when processing neural network architectures. For instance, as transformers and other types of neural network modeling techniques grow more popular, typical processing units (e.g., CPUs, GPUs) may be unnecessarily slow due to a theory of design intended for broader implementation use cases. For instance, a neural network architecture, sub-neural network, or child neural network performs computer vision or object recognition by implementing various GPTs (or other types of transforms) on the image sensor data, beneficially replacing previous techniques for post-processing of vision neural networks. The TRIP unit 192 is designed specifically for neural network operations allowing the GPT transformers to run natively in the computing components of the ego 140, such that the TRIP units 192 provide faster and more efficient processing than traditional GPUs 191 or CPUs 193 executing similar GPT transformations. In this way, the TRIP units 192 mitigates or eliminates latency and improves overall efficiency, contributing to the ability of the ego 140 to make real-time decisions. Moreover, the structural design and design theory of the TRIP units 192 draw comparatively less power than traditional GPUs 191 or CPUs 193 when performing more sophisticated and complex functions of neural network architectures, such as the transformer networks (e.g., transformers).

The ego computing device 141 may execute software programming defining an execution scheduler 182, which determines which component of the SD circuit 150 should execute which operations of the neural network architecture. During training or inference time, the ego computing device 141 extracts features or tensors from the input sensor data gathered from the sensors of the ego 140, which the ego computing device 141 feeds to the various neural network architecture or sub-architectures for various operations (e.g., computer vision, object recognition). The ego computing device 141 applies a graph partitioner on the sensor data to generate data partitions or portions. The ego computing device 141 applies a set of compilers (not shown), which may logically form a compiler toolchain for the neural network architecture of the ego 140, for compiling and debugging the code for executing layers of the neural network architecture for sensor-data interpretation. Each compiler is used to transform the high-level programming language into machine code comprising execution instructions, executed by the hardware of the SD circuit 150. The compilers may be configured or optimized to compile the programming code according to the specific architectures or types of the processing units (e.g., CPU 193, GPU 191, or specialized TRIP unit 192 hardware) of the SD chips 152. The linker of the execution scheduler 182 may combine multiple compiled pieces of code (e.g., executable instructions) into one or more executable files or data stream for an execution schedule (not shown).

The linker and execution scheduler 182 obtains the set of execution instructions and maps the execution instructions into the hardware components (e.g., GPUs 191, TRIP units 192, CPUs 193) of the SD circuit 150 to perform the particular execution instructions. In some implementations, the linker of the execution scheduler 182 is trained to optimize the operations to be performed in the hardware components of the SD circuit 150. The linker is trained to determine or preconfigured with temporal or latency demands for the hardware components to perform the operations of the execution instructions. This often possible because such performance-timing or latency metrics are known, essentially static, quickly calculated, or prestored. In this way, the linker maps the execution instructions to the components of the SD circuit 150 according to the minimized or optimized latency. Additionally or alternatively, the linker determines which hardware components of the SD circuit 150 should perform which execution instructions based upon characteristics of the execution instructions (e.g., which compiler generated the machine code of the execution instruction). In this way, the linker maps the execution instructions to the processing units based upon the compiler that generated the particular execution instruction.

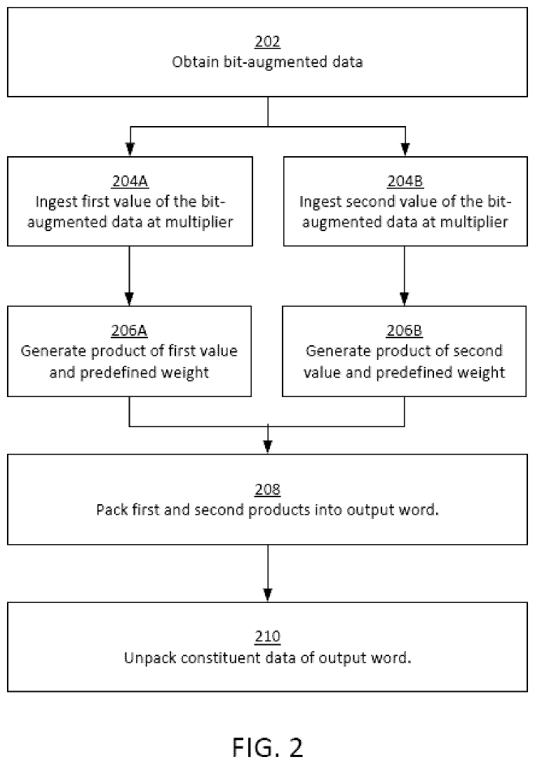

FIG. 2 illustrates an example of a flow diagram 200 for transfer of bit-augmented binary-coded data, according to some embodiments. The bit-augmented binary-coded data be data processed by one or more layers of a convolutional network, such as may be transferred incident to an operation of one or more of the AI model(s) 110c. The AI model(s) 110c may be implemented via components of a hardware pipeline configured to execute convolutions across large datasets. For example, the hardware pipeline can include large numbers of multiplier-accumulators (MACs) (e.g., thousands) operating in parallel to execute convolutional neural networks such as residual networks (ResNets). Some instances of the AI model(s) 110c (e.g., updated transformer or other AI model 110c instances) can execute fewer convolutional operations than traditional CNN implementations, or can operate at greater bit-widths than are supported by various memories or data buses. At the same time, the updated models can exchange certain information at a higher total throughput than the traditional CNN implementations. For example, the ego computing device 141 can execute softmax functions or layer normalization functions (LayerNorm) such as root-mains squared layer normalization (RMSNorm), incident to the execution of the AI model(s) 110c. Such execution can aid the operation of a perception system of an ego 141 such as an autonomous vehicle 140a or a robot 140b. However, according to some implementations, the latency or throughout of such executions may be constrained by data transference between components of a hardware pipeline, while MACs may be underutilized (e.g., according to a diminished demand for convolutional operations). Accordingly, according to the present disclosure, MACs may be used to increase data throughput, as by packing data words into reduced bit-widths.

At operation 202, bit-augmented data is obtained by a circuit. The circuit can include MACs for convolving a data structure with weights of a machine learning model. For example, in some embodiments, the bit-augmented data can include data elements which natively exceed a bit-width of a memory bus, MAC, or register of the circuit. For example, sixteen-bit data can be provided for a circuit including an eight-bit memory bus or a register. Such information can be referred to as bit-augmented data elements, where a bit-width data element exceeds a bit-width of a hardware component of a circuit.

In some embodiments, the bit-augmented data can include data elements which exceed an aggregate throughput of a memory component, transport bus, logical operator, or other component of a hardware pipeline, but may not individually exceed a native bit-width of a memory bus, MAC multiplier, or register. For example, ten-thousand bytes of data can be provided per clock cycle, for a system including at least one component constrained to five-thousand bytes of data per cycle. Such information can be referred to as bit-augmented aggregate data, where the logical data elements, at least in aggregate, exceed a hardware component of a circuit.

For either of bit-augmented aggregate data or bit-augmented data elements, constituent data values can be identified, having first and second bit-widths (which may be the same or different from each other). For example, for a sixteen-bit bit-augmented data element, a MSB and LSB may be identified. Similarly, for bit-augmented aggregate data, a first of the data elements and a second of the data elements may be identified. In some embodiments, the identified data elements include a relationship therebetween, such as the LSB and MSB (e.g., where discretization error of an LSB may impact system operation less than discretization error of an MSB). Such relationships may further be identified between distinct values. For example, discretization error incurred by a rear facing camera may impact a system less than discretization error incurred by a front facing camera, or discretization error of a radar, red channel information, or blue channel information may impact a system differently.

The data may be obtained according to a serial channel or parallel transfer (e.g., register transfer). For example, the data may be obtained according to an interleaving of first values with second values (e.g., different data types organized according to an impact of discretization error, as in the case of an MSB and an LSB). In some embodiments, various instances of the first values with second values are obtained at various inputs to a circuit. For example, hundreds or thousands of instances of the first values and second values may be obtained at corresponding hundreds or thousands of inputs of the circuit.

At operation 204a, a first of the data values is received by a multiplier (e.g., a binary multiplier of a MAC). At operation 204b, a second of the data values is received by the multiplier. For example, the multiplier of operations 204a and 204b can be a same multiplier as is configured to receive the respective data values according to the interleaving of operation 202. The MAC or other multiplier can further receive a predefined multiplicand corresponding to the various first and second values. The predefined multiplicands may be referred to as “weights” without limiting effect. For example, the above-described MAC can be a MAC of a MAC array configured to convolve kernels of weights with an image or other input data structure of a layer of a machine learning model, wherein the image or other input data structure is referred to as an input and the kernel values provided for convolution with the image or other input data structure is referred to as including the weights of the model.

At operation 206a, the multiplier (e.g., MAC) can generate a first product from a first of the weights (the weight being a predefined weight) and a first value. The first of the weights can be a power of two so as to generate the first product as a left-shifted instance of the first value. For example, a predefined weight of 256 can shift a first input of an MSB to an MSB position at an output of the hardware multiplier, such as an adder or accumulator of a MAC including the hardware multiplier. Other values can be selected according to other bit-widths (e.g., 0x10 for four-bit values or 0x10000 for thirty-two-bit values). Such an operation may leave as unoccupied the LSB of the output, such that a LSB or other second value can occupy some of the least significant bits of the output, storing both of the first value and second value without discretization error. For example, the predefined weight of 256 can be realized according to a carry in bit or other function of an eight-bit MAC. However, in some instances, the MAC may lack such functionality, or an output of the MAC (or other components coupled therewith) may otherwise be configured to receive such information. For example, where an uppermost bit of a component downstream of the MAC is configured to operate with floating point numbers, such circuitry may right shift the first value (subsequent to the left-shifting) to avoid setting a negative flag of the uppermost bit. Such a right shift may prove destructive to an uppermost bit of the second value packed into a location overlapping with the lowermost bit of the first value, effectively reducing the precision of the combined value to half precision (e.g., reducing 16-bit precision to 8-bit precision).

As another example, in the case of a data format of bfloat (BF15), the first value may be a MSB and the second value may be a least significant bit (LSB), where the MSB is left-shifted by 7 bits using a predefined weight (e.g., 128), and the LSB is added directly using a weight of 1. This results in a 15-bit packed value that can be processed using an 8-bit MAC pipeline.

In some embodiments, another predefined weight, such as a predefined weight to left shift the first value (e.g., MSB) by less than a bit-width of the first value may be used. For example, by bit shifting the MSB by 128, the multiplication for the left-shift can be executed by an eight-bit multiplier. However, such an operation leaves only seven bits to store an LSB, effectively reducing total realizable precision to fifteen-bit precision (however, such an approach may be preferable to losing a MSB of the second value). In some embodiments, the left shifted value is multiplied by two, subsequent to the previous multiplication, thereby left-shifting the first value to an upper half of an output of the multiplier, so as to realize sixteen-bit precision.

At operation 206b, the multiplier (e.g., MAC) can generate a second product from a second of the weights (being a predefined weight) and the second value. For example, the predefined weight can be selected as one (or 0.5, in some embodiments, to realize a right shift to store all but a least significant bit of the second value). Operation 206b can be performed be a same or different MAC as the one or more MACs of operations 204a, 204b, and 206a.

At operation 208, the respective products generated at operations 206a and 206b are packed into an output word. As indicated above, such packing can include a truncation of a least significant bit (LSB) of a second value. In some embodiments, the packing (and other operations of the present data flow) may be performed according to pipelined operation. For example, upon a receipt of a first instruction (e.g., strobe or clock edge), a first value may be obtained at a multiplier input. Upon a receipt of a second instruction, a first product may be realized from the first input and the first predefined weight. Upon a receipt of a third instruction, a second value may be obtained at the multiplier input and the first product can be re-registered (e.g., into an adder or accumulator). Upon a receipt of a fourth instruction, a second product may be realized from the second input and the second predefined weight. Upon a receipt of a fifth instruction, the first product may be summed with the second product to realize a packed output word (which may be of reduced precision according to LSB truncation, in some embodiments). Hence the output word can be generated using each of the first product, the second value, the first predefined wight, and the second predefined weight. Upon a receipt of a sixth instruction, the output word can be conveyed to another component of a hardware pipeline or a memory location and register values can be cleared to receive a subsequent first and second value.

A bit-width of the output word can vary according to a particular architecture, but is understood to correspond to an accumulator of the MAC. For example, most eight-bit MACs will include a sixteen-bit output word, most sixteen-bit MACs will include a thirty-two-bit output word, and so forth. In some cases, a word size with is not double a multiplier of the MAC. Some MACs can be configured with asymmetric inputs. For example, a MAC configured to receive alternating four and eight bit inputs can include a twelve-bit accumulator. In such a system, the word can refer to twelve bits, or sixteen bits according to bit-padding.

At operation 210, the output word packed at operation 208 is unpacked. For example, operation 210 can take place distal to a throughput-constrained portion of the hardware pipeline, downstream of the multiplier of operations 204 and 206. That is, the packed output word can increase a data throughput realized at a throughput-constrained portion of the hardware pipeline. In some embodiments, the output word is unpacked according to multiple instances of the word. For example, a first hardware component can ingest the packed output word and generate an output representative of the first value having a same bit-width of any of the output word, the first value, or the second value. A second hardware component can ingest the packed output word and generate an output representative of the second value having a same bit-width of any of the output word, the first value, or the second value. In some embodiments, the first and second hardware components are a same hardware comment. For example, such a hardware component can be implemented as a single-instruction multiple-data component, configured to, upon receipt of an instruction, convey data elements representative of the first and second values to one or more storage locations. In some embodiments, the respective values can be stored at separately addressable locations. For example, such an operation can be received according to a seventh strobe, clock edge, or other instruction subsequent to the sixth instruction.

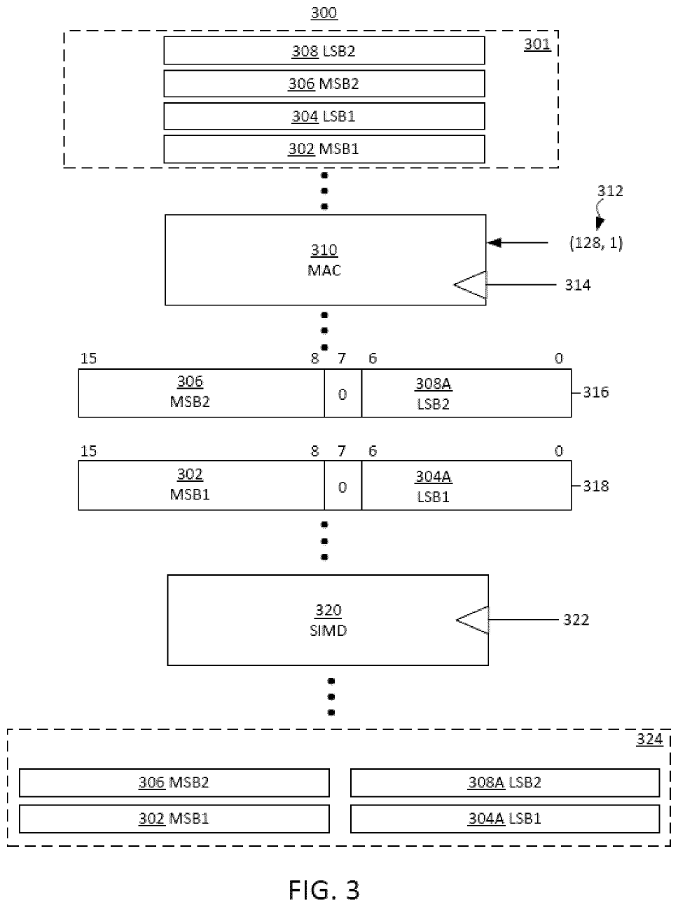

FIG. 3 illustrates a logical example of a hardware pipeline 300, according to some embodiments. For example, the hardware pipeline 300 can implement various of the operations of FIG. 2, in some embodiments. A data source 301 such as a serial stream or memory bus can ingest data values into the circuit. Particularly, in the depicted example, the data source 301 is an eight-bit bus. Input values can be received in the bus, without regard to a bit-width thereof. For example, example data elements are shown according an interleaved MSB and LSB. Particularly, a first MSB 302, first LSB 304, second MSB 306, and second LSB 308 can be ingested, serially, into the hardware pipeline. These example values are provided as an illustrative segment of a data stream, which can include additional data. For example, a system operating in the megahertz or gigahertz range can include millions or billions of these values per second. Although four values are depicted, these values are understood to represent data across time. For example, for an eight-bit data bus, eight bits can be provided at a time; for a serial stream, one bit can be provided at a time. Such data elements are provided merely to aid in a description of particular examples of the operation of the of the hardware pipeline 300 and are not intended to limit it. The data stream can include any of various input data element types, such as a video stream or other sensor data stream of a perception or autonomy system of an ego 141.

In some embodiments, the depicted MSB and LSB are portions of a same data element (e.g., sixteen-bit sensor data of a sensor, such as any of the various sensors of an ego 141 as depicted in FIG. 1B). In some embodiments, the depicted MSB and LSB are derived from separate data elements, such as data from different sensors or different portions of a same data structure (e.g., image data). That is, regardless of a relationship between the MSBs and LSBs, the hardware pipeline can increase a data throughput passed over a throughput-constrained portion of a pipeline, according to some embodiments.

A multiplier-accumulator (MAC) 310 can ingest, from the data source 301, the data values as one multiplicand. The MAC 310 can further ingest predefined weights 312, such as a unity multiplicand of one, and another multiplicand configured to left-shift an input value by a bit width equal to or less than (e.g., one less than) a bit width of an input. The multiplicands may be received as a same bit-width to generate a product thereof double of the same bit-width (e.g., may generate a sixteen-bit product of two eight-bit multiplicands). In various embodiments, either of the MSB or the LSB can be obtained by the MAC 310 before the other of the MSB or LSB. That is, in some embodiments, the interleaving of the MSB and LSB can be inverted.

The MAC 310 can receive an instruction such as a clock, strobe, enable, or so forth. Such an instruction can be shared with further elements of the hardware pipeline 300 to synchronize the flow of data therethrough. For example, the MAC 310 and the data source 301 can receive a same instruction to cause the MSBs and LSBs to be input into the MAC 310, and to cause the MAC 310 to process the input data and the weights (e.g., to determine a product thereof). References to a same instruction are not intended to refer to synchronicity thereof. Indeed, in some embodiments, signals may be intentionally delayed or skewed within an instruction cycle to avoid race conditions.

The MAC 310 can multiply the MSB values by one of the predefined weights to align the MSB into a predefined position at an output of the MAC 310 (e.g., in a most significant portion). For example, according to various embodiments, the MSB can be placed into bits 14:7, according to multiplication with a predefined weight of 128, to left-shift the MSB seven bits. In some embodiments (as is depicted) the MSB can be placed into bits 15:8. The output of the MAC 310 can refer to an accumulator or other type a register of the MAC 310 coupled with an output of the multiplier (e.g., an adder or accumulator register), or a register or other memory location exterior thereto. In some cases, the data may be shifted or moved by the downstream component from the accumulator or other register to addressable or non-transitory memory that is accessible by other components. For example, the output words 316, 318 can be provided from the MAC 310 to another component of the hardware pipeline 300. Although each MAC 310 can include a single accumulator register, a first instance 316 and second instance 318 of the output word are depicted to correspond to the depicted segment of the data source 301. These output words 316, 318 can be provided in the accumulator register serially. That is, the first instance 316, corresponding to the first MSB 302 and first LSB 304 can be provided prior to a transfer to another circuit portion, such as the depicted SIMD 320, prior to the provision of the second instance 318, corresponding to the second MSB 306 and second LSB 308.

The LSBs can be stored at bits 7:0 or, as is depicted, bits 6:0 of the output words 316, 318. That is, a reduced precision instance of the first LSB 304A and second LSB 308A can be stored at bits 6:0. Although the omitted bit is depicted as a seventh bit, the truncated bit of the LSB can be selected as a least significant bit. For example, the endianness of the LSB can be inverted, or the input data can be right shifted so as to underflow a LSB and align the seven MSB with the depicted position. In some embodiments, such an operation is performed by another MAC 310 or other portion of the hardware pipeline 300.

The output words 316, 318, including at least a portion of each of the MSB and LSB, can be referred to as a packed word. The depicted instances of the output words 316, 318 include (or “pack”) the MSB as received, and seven MSB of the LSB as received. The packed words are received by a hardware component downstream of the MAC 310. The downstream component is configured to store the packed values of the accumulator into separate locations. For example, in some embodiments, the separate locations are separately addressable. In some embodiments, the downstream component is a SIMD device configured to store the packed values into separate locations according to a receipt of a single instruction 322. For example, the separate locations can be severely addressable locations of a register or other downstream memory 324. In some embodiments, the instruction 322 is a same pipeline instruction 322 as is received by other components of the hardware pipeline. For example, the instruction 322 can include the strobe, clock edge, or enable received by the MAC 310 or the input data source 301.

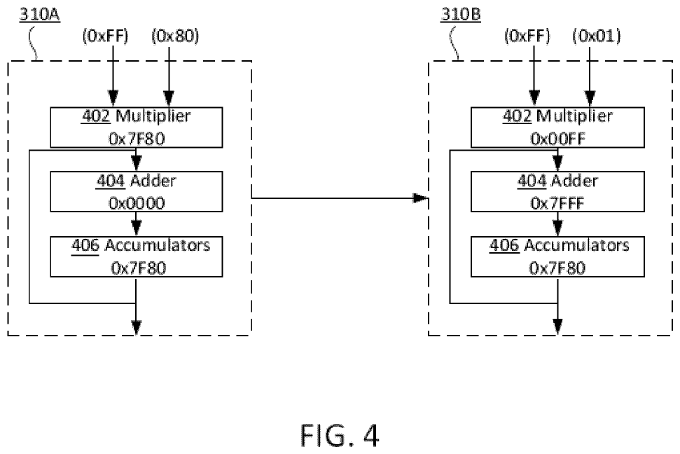

FIG. 4 illustrates an example of state of the MAC 310 incident to a receipt of instructions 322 therefor, according to some embodiments. Particularly, the depicted example illustrates a state of various MAC registers according to a multiplication of an MSB of 0xFF with a predefined weight of 128, and an LSB of 0xFF with a predefined weight of 1. The first state of the MAC 310A depicts a product of the inputs as 0x7F8 (left shifting the input value by seven bits). Such an illustrative embodiment is non-limiting. For example, in some embodiments, as in the example register format depicted in FIG. 3, the MAC 310 can generate a value of 0xFF00.

Subsequent to such an operation, the MAC 310 can receive a second input of the LSB of 0xFF and the predefined weight of one, as depicted at the second state 310B. For example, the MAC 310 can be a MAC 310 of a MAC array configured to convolve a two-by-one kernel of [128 1] with an input data structure (e.g., image data or other sensor data). The first product of the left-shifted value 0x7F80 can be shifted to an adder 404 or, as depicted, accumulator 406. The second input of 0xFF can be multiplied with the second predefined weight (of unity) to position the second input in the least significant bits of the multiplier output. Although depicted as received by the multiplier 402 as 0xFF, in some embodiments, a LSB can be truncated prior to such ingestion (e.g., the MAC 310 can receive a value of 0xFE or 0x7F representing a saturated 7-bit data value). The first and second products can thereafter be summed to realize a value of 0x7FFF according to fifteen-bit precision (or, in some embodiments, 0xFFFF according to sixteen-bit precision). In some embodiments, the depicted value can differ from a literal sequence of bits in a register. For example, where an 8th bit of a register is omitted as is depicted in FIG. 3, the logical fifteen-bit value of value of 0x7FFF can be stored as a register value of 0xFF7F. The zero value allows the result of the convolution to be left shifted by one to obtain a 15 bit value. For example, the 0x7F in the upper bit can be left shifted to 0xFF without producing an overflow. Such a feature can be omitted in some implementations, according to some carry bit implementations.

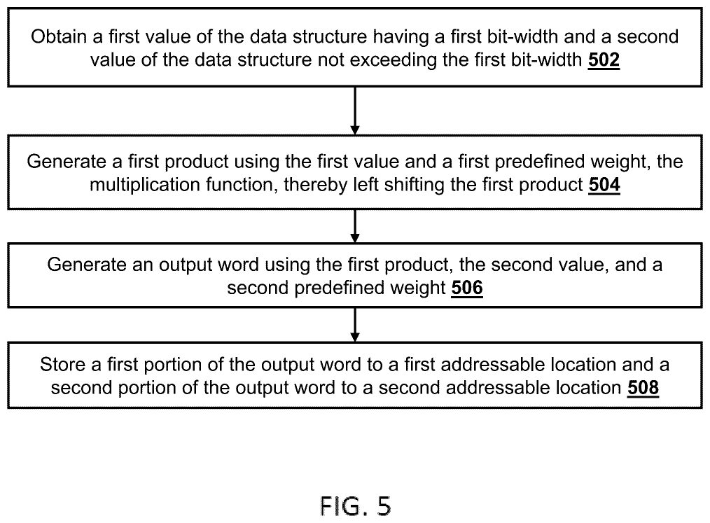

FIG. 5 illustrates an example of a method 500 of bit-augmented data transference, according to some embodiments. The method 500 can be performed by a circuit (e.g., one or more circuits of the compute device). The circuit can include a multiplier-accumulator (MAC) for convolving a data structure with weights of a machine learning model. For example, the MAC can correspond to any of the MACs 310 of FIG. 3, FIG. 4 or as otherwise provided herein.

At operation 502, the circuit obtains a first value having a first bit-width and a second value having the first bit-width. The first value and the second value can include pixel data for a first and second pixel of an image or other data. In some embodiments, the first and second pixel can correspond to data of a same pixel (e.g., an MSB and LSB thereof), or can refer to separate pixels. The first value and the second value can be obtained, by the MAC, via a serial stream, register transfer, or other parallel transfer. For example, the first value and the second value can be obtained via a parallel transfer having the first bit-width.

At operation 504, the circuit uses using a multiplication function of the MAC to generate a first product using the first value and a first predefined weight, the multiplication function, thereby left shifting the first product. The left-shift can be of a number of bits equal to or less than the number of bits of the first bit width. For example, the left-shift can be of a number of bits which is one less bit than a multiplier width of the MAC (e.g., using a multiplicand of 128 for an eight-bit MAC, with an eight-bit first bit-width).

At operation 506, the circuit uses the multiplication function of the MAC to generate an output word using the first product, the second value, and a second predefined weight. For example, the circuit can sum the first product with a product of the second value and the second predefined weight. The second predefined weight can be a weight of one, so as to render the second product equal to the second value. However, the output word can include further shifts or truncations according to a particular hardware implementation (e.g., to accord to a multiplier width). In some embodiments, the output word is generated according to a simultaneously storing, in an accumulation register of the MAC, the first product and a second product of the second value and the second predefined weight, the first product stored at a first portion of the accumulation register and the second product stored at a second portion of the accumulation register. The simultaneous storing need not be initiated simultaneously. For example, a first product can be stored and maintained in memory until the second product is stored, such that the products are simultaneously stored upon the receipt of the second product.

At operation 508, the circuit stores a first portion of the output word to a first addressable location and a second portion of the output word to a second addressable location, different from the first addressable location. The storage may be responsive to receipt of an instruction. For example, the instruction can be received as one of a rising edge or a falling edge (e.g., of a clock, strobe, or other enable signal). In some embodiments, a data format for the output word includes a sign bit for an uppermost bit, and each of the first value, the second value, the first predefined weight, and the second predefined weight are natural numbers (e.g., the output word can be formed as a fifteen-bit value exclusive of a sign bit).

In some embodiments, the first addressable location and the second addressable location are addressable by a component in a pipeline including the SIMD component and the MAC, the component disposed downstream of the SIMD component and the MAC. For example, the pipeline can flow from the MAC to the SIMD component, from the SIMD component to the addressable locations (e.g., register or other memory), and on to the downstream component. In some embodiments, providing the output word to a single instruction multiple data (SIMD) component configured to store the first portion of the output word to the first addressable location and the second portion of the output word to the second addressable location is performed responsive to a same instance of the instruction. The joint cumulative size of the first addressable location and the second addressable location can exceed a per-instruction bandwidth of the circuit. For example, each of the first addressable location and the second addressable location can be sixteen-bit locations, and the circuit can be configured to convey sixteen bits per instruction; or each of the first addressable location and the second addressable location can store one data element per cycle where a bottleneck of the circuit can transfer one such data element per cycle.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for data transport comprising:
obtaining, by a circuit comprising a multiplier-accumulator (MAC) for convolving a data structure with weights of a machine learning model, a first value of the data structure having a first bit-width and a second value of the data structure not exceeding the first bit-width;
generating, using a multiplication function of the MAC of the circuit, a first product using the first value and a first predefined weight, the multiplication function, thereby left shifting the first product;
generating, using the multiplication function of the MAC of the circuit, an output word using the first product, the second value, and a second predefined weight; and
storing, upon receipt of an instruction, a first portion of the output word to a first addressable location and a second portion of the output word to a second addressable location, different from the first addressable location, whereby a cumulative size of the first addressable location and the second addressable location exceeds the first bit-width.

2. The method of claim 1, further comprising simultaneously storing, in an accumulation register of the MAC, the first product and a second product of the second value and the second predefined weight, the first product stored at a first portion of the accumulation register and the second product stored at a second portion of the accumulation register.

3. The method of claim 2, further comprising providing the output word to a single instruction multiple data (SIMD) component configured to store the first portion of the output word to the first addressable location and the second portion of the output word to the second addressable location responsive to a same instance of the instruction.

4. The method of claim 3, wherein the first addressable location and the second addressable location are addressable by a component in a pipeline including the SIMD component and the MAC, wherein the component is disposed downstream of the SIMD component and the MAC.

5. The method of claim 1, wherein the second predefined weight is one.

6. The method of claim 1, wherein the left shift is by fewer bits than the first bit-width.

7. The method of claim 1, wherein a data format for the output word comprises a sign bit for an uppermost bit, and each of the first value, the second value, the first predefined weight, and the second predefined weight are natural numbers.

8. The method of claim 1, wherein the instruction is received as one of a rising edge or a falling edge.

9. The method of claim 1, wherein the first value and the second value are obtained, by the MAC, via a serial stream.

10. The method of claim 1, wherein the first value and the second value comprise pixel data for a first and second pixel of an image.

11. A system for data transport, the system comprising:
a circuit comprising a multiplier-accumulator (MAC) for convolving a data structure with weights of a machine learning model and configured to:
obtain a first value of the data structure having a first bit-width and a second value of the data structure not exceeding the first bit-width;
generate, using a multiplication function of the MAC, a first product using the first value and a first predefined weight, the multiplication function, thereby left shifting the first product;
generate, using the multiplication function of the MAC, an output word using the first product, the second value, and a second predefined weight; and
store, upon receipt of an instruction, a first portion of the output word to a first addressable location and a second portion of the output word to a second addressable location, different from the first addressable location, whereby a joint cumulative size of the first addressable location and the second addressable location exceeds the first bit-width.

12. The system of claim 11, wherein the circuit is configured to store, simultaneously, in an accumulation register of the MAC, the first product and a second product of the second value and the second predefined weight, the first product stored at a first portion of the accumulation register and the second product stored at a second portion of the accumulation register.

13. The system of claim 12, wherein the circuit is configured to provide the output word to a single instruction multiple data (SIMD) component configured to store the first portion of the output word to the first addressable location and the second portion of the output word to the second addressable location responsive to a same instance of the instruction.

14. The system of claim 13, wherein the first addressable location and the second addressable location are addressable by a component in a pipeline including the SIMD component and the MAC, wherein the component is disposed downstream of the SIMD component and the MAC.

15. The system of claim 11, wherein the second predefined weight is one.

16. The system of claim 11, wherein the left shift is by fewer bits than the first bit-width.

17. The system of claim 11, wherein a data format for the output word comprises a sign bit for an uppermost bit, and each of the first value, the second value, the first predefined weight, and the second predefined weight are natural numbers.

18. The system of claim 11, wherein the MAC is configured to obtain the first value and the second value via a register transfer of the first bit-width.

19. An autonomous vehicle comprising:
one or more sensors configured to generate a data structure having a plurality of data elements; and
a circuit comprising a multiplier-accumulator (MAC) for convolving the data structure with weights of a machine learning model and configured to:
obtain a first value having a first bit-width and a second value not exceeding the first bit-width;
generate, using a multiplication function of the MAC, a first product using the first value and a first predefined weight, the multiplication function, thereby left shifting the first product;
generate, using the multiplication function of the MAC, an output word using the first product, the second value, and a second predefined weight; and
store, upon receipt of an instruction, a first portion of the output word to a first addressable location and a second portion of the output word to a second addressable location, different from the first addressable location, whereby a joint cumulative size of the first addressable location and the second addressable location exceeds a per-instruction bandwidth of the circuit.

20. The autonomous vehicle of claim 19, wherein the circuit is configured to provide the output word to a single instruction multiple data (SIMD) component configured to store the first portion of the output word to the first addressable location and the second portion of the output word to the second addressable location responsive to a same instance of the instruction,
wherein the first addressable location and the second addressable location are addressable, by a component in a pipeline including the SIMD component and the MAC, and wherein the component is disposed downstream of the SIMD component and the MAC.
